(19) United States
(12) Patent Application Publication
(10) Pub. No.: US 2014/0328165 A1
(43) Pub. Date: Nov. 6, 2014

(54) METHOD AND APPARATUS FOR PROTECTION SWITCHING IN ROOTED MULTIPOINT (RMP) CONNECTION NETWORKS

(71) Applicant: ELECTRONICS AND TELECOMMUNICATIONS RESEARCH INSTITUTE, Daejeon (KR)

(72) Inventors: Jeong Dong RYOO, Daejeon (KR); Tae Sik CHEUNG, Daejeon (KR); Dae Ub KIM, Daejeon (KR)

(73) Assignee: ELECTRONICS AND TELECOMMUNICATIONS RESEARCH INSTITUTE, Daejeon (KR)

(21) Appl. No.: 14/269,538

(22) Filed: May 5, 2014

(30) Foreign Application Priority Data
May 3, 2013 (KR) 10-2013-0049909
Apr. 3, 2014 (KR) 10-2014-0039915

(51) Int. Cl. H04L 12/703; H04W 40/24

(52) U.S. Cl. CPC H04L 45/28; H04W 40/24
USPC 370/228

(57) ABSTRACT

A method of operating a root node in which the root node transmits/receives traffic with a plurality of leaf nodes through a plurality of working paths is disclosed, the method including receiving, from a first leaf node, a first signal failure (SF) message indicating an occurrence of a failure on a first working path of the first leaf node, receiving traffic from the first leaf node by switching the first working path to a first protection path, and receiving traffic from remaining leaf nodes aside from the first leaf node while maintaining the working path.

### CROSS-REFERENCE TO RELATED APPLICATION

This application claims the priority benefit of Korean Patent Application No. 10-2013-0049909, filed on May 3, 2013, and Korean Patent Application No. 10-2014-0039915 filed on Apr. 3, 2014 the Korean Intellectual Property Office, the disclosure of which is incorporated herein by reference.

### BACKGROUND

1. Field of the Invention

The present invention relates to a method and apparatus for a protection switching that allows a rapid protection switching to an alternative path when a failure occurs on a transmitting/receiving path in a point-to-multipoint connection network, for example, a rooted multipoint (RMP) connection network.

2. Description of the Related Art

Recent forms of packet transport network technology, such as an optical transport network (OTN), Ethernet, and a multiprotocol label switching transport profile (MPLS-TP), include a method of performing a switching state management and a path protection switching using an automatic protection switching (APS) message for a linear protection switching, for example, OTN linear protection defined in Telecommunication Standardization Sector of the International Telecommunications Union (ITU-T) G873.1, Ethernet linear protection defined in ITU-T G8031, and MPLS-TP linear protection switching defined in Internet Engineering Task Force (IETF) document draft-zulr-mpls-tp-linear-protection-switching-03.txt and ITU-T G8131.1, and a method of performing a switching state management and a path protection switching using a protection state coordination (PSC) message defined in IETF request for comments (RFC) 6378 and ITU-T G8131.2.

The protection switching represents a method of rapidly resuming transmitting of traffic using an alternative path when the transmitting is suspended due to a network failure. In a current linear protection switching, a working path is set not to encounter a protection path for traffic flowing in both directions or a single direction between point-to-point, and the traffic is transmitted through the protection path in an occurrence of a failure in the working path or when instructed by a command of an operator whereas the traffic is normally transmitted through the working path.

In most packet transmission networks, the linear protection switching method includes generating a plurality of virtual connection paths between management points, setting two entities of a working path and a protection path as a protection group from among the plurality of virtual connection paths. When a failure occurs on a predetermined connection path in the set protection group, a maintenance end point (MEP) recognizes the failure, and an automatic protection switching process performs a protection switching. FIG. 1 illustrates an unmodified ITU-T G8031 Ethernet linear protection switching structure. Here, a linear protection switching function is executed by a sub-network connection (SNC) protection switching process, and the SNC protection switching process sets the positions of bridge and selector to send and receive the traffic.

However, a conventional method of assigning an individual virtual local area network (VLAN) for a point-to-point connection is at a disadvantage in that a root node undergoes an occurrence of a heavy load because traffic needs to be copied in the root node to correspond to a number of a plurality of leaf nodes or all leaf nodes, and transmitted through a plurality of differing VLANs when multicast traffic or broadcast traffic is transmitted from the root node to the plurality of leaf nodes.

The IEEE 802.1Q standard discloses a method of using an asymmetric VLAN for a rooted multipoint (RMP) connection network. The asymmetric VLAN method includes assigning different VLANs based on a direction of traffic. For example, in the asymmetric VLAN method, an RMP connection network is formed when one VLAN is assigned in a direction leading to all leafs from a root node, and another VLAN is assigned for traffic leading to the root node from all the leaf nodes. As such, two asymmetric VLANs are employed to form a working tree, and another two asymmetric VLANs are used to form a protection tree to be used for traffic protection when a failure occurs in the working tree. However, a conventional Ethernet transmission function defined in an Ethernet standard may need to conceive novel functions in order to apply a per-leaf protection switching to the RMP connection network using a total of four asymmetric VLANs as described above. The conventional Ethernet transmission function is restricted in that a leaf node that transmits an Ethernet frame received by an Ethernet root node needs to determine when an Ethernet frame transmitted from a leaf node to a root node has an identical VLAN identification (ID) because the per-leaf protection switching is characterized by receiving traffic transmitted from a predetermined leaf node through a working tree and receiving traffic transmitted from another leaf node through a protection tree.

Accordingly, there is a desire for a development in the conventional technology as the per-leaf protection switching with respect to the RMP connection network using the asymmetric VLAN is yet to be devised.

### SUMMARY

A technical solution of the present invention aims to perform an appropriate protection switching when a network is configured in a form of point-to-multipoint. According to the present exemplary embodiment, there is provided a method and apparatus for protection restoration in a rooted multipoint (RMP) connection network including a plurality of leaf nodes connected to a root node. As used herein, the term “root node” refers to a node logically connected to multiple points in the form of point-to-multipoint for communication.

In the RMP connection network, when a large number of leaf nodes experiencing suspended traffic transmission in an occurrence of a failure are present, a per-tree protection switching method in which an entire network is switched at once to use a protection tree may be employed for rapid restoration. However, the method has an issue of an unprotected leaf node occurring when a failure occurs in a working tree for one leaf node and a failure occurs in a protection tree for another leaf node. Therefore, a per-leaf protection switching method in which a leaf node recognizing a failure on a working tree uses a protection tree may be proposed as a solution to such an issue. To this end, a configuration of a VLAN required for the per-leaf protection switching and a method and apparatus thereof are provided.

According to an aspect of the present invention, there is provided a method of operating a root node, the method including receiving, from a first leaf node, a first signal failure (SF) message indicating an occurrence of a failure on a first working path corresponding to the first leaf node from among a plurality of leaf nodes that transmits/receives at least one of transmitting traffic and receiving traffic through a plurality of working paths, receiving, from the first leaf node by switching the first working path to a first protection path, receiving traffic, and receiving, from remaining leaf nodes aside from the first leaf node, receiving traffic through each of remaining working paths aside from the first working path.

The method may further include transmitting a first no request (NR) message to each of the plurality of leaf nodes, and receiving a second NR message from each of the plurality of leaf nodes.

The method may further include copying transmitting traffic, and transmitting the copied transmitting traffic through the first working path and the first protection path concurrently when the SF message is received.

The method may further include transmitting, to the first leaf node, a third NR message indicating completion of the switching.

The method may further include transmitting, to the remaining leaf nodes aside from the first leaf node, a fourth NR message that instructs a working path through which the transmitting/receiving of the transmitting traffic and the receiving traffic is performed be maintained.

The method may further include receiving, from the first leaf node, a wait to restore (WTR) message indicating a clearance of the failure and a start of WTR timer to see if the clearance of the failure is persistent.

The method may further include determining that the failure in the first leaf node is cleared, and receiving, from the first leaf node, a fifth NR message indicating that a WTR timer is expired.

The method may further include receiving, by switching to the first working path from the first protection path, receiving traffic when the fifth NR message is received.

According to another aspect of the present invention, there is provided a method of operating a leaf node, the method including transmitting/receiving, with a root node, at least one of transmitting traffic and receiving traffic through a working path, detecting an occurrence of a failure on the working path, receiving, by switching the working path to a protection path, receiving traffic, transmitting an SF message indicating the occurrence of the failure on the working path, and receiving a first NR message indicating that the root node performs the switching.

The method may further include transmitting a second NR message to the root node, and receiving a third NR message from the root node.

The method may further include copying transmitting traffic and performing transmitting of the copied transmitting traffic through the working path and the protection path concurrently, or performing transmitting of transmitting traffic through the protection path.

The method may further include transmitting a fourth NR message to the root node subsequent to the switching being performed.

The method may further include detecting a clearance of the failure.

The method may further include transmitting, to the root node, a WTR message indicating the clearance of the failure and a start of WTR timer to see if the clearance of the failure is persistent.

The method may further include transmitting the WTR message, and initiating a WTR timer, and transmitting a fifth NR message to the root node in response to the WTR timer being expired.

The fifth NR message may be a message that instructs the root node to receive to receiving traffic by switching to the working path from the protection path.

The method may further include transmitting/receiving at least one of transmitting traffic and receiving traffic by switching to the working path from the protection path in response to the WTR timer being expired.

According to still another aspect of the present invention, there is provided a root node, including a communicator to receive, from a first leaf node, a first SF message indicating an occurrence of a failure on a first working path corresponding to the first leaf node from among a plurality of leaf nodes that transmits/receives at least one of transmitting traffic and receiving traffic through a plurality of working paths, and a controller to control the communicator to receive, from the first leaf node, receiving traffic by switching the first working path to a first protection path, and to receive, from leaf nodes remaining aside from the first leaf node, receiving traffic through each of working paths aside from the first working path.

According to yet another aspect of the present invention, there is provided a leaf node, including a communicator to transmit/receive, with a root node, at least one of transmitting traffic and receiving traffic through a working path, and a controller to control the communicator to receive receiving traffic by switching the working path to a protection path when an occurrence of a failure is detected on the working path, wherein the communicator transmits an SF message indicating the occurrence of the failure on the working path, and receives a first NR message indicating that the root node performs the switching.

The communicator may copy transmitting traffic and transmit the copied transmitting traffic through a working path and a protection path concurrently, or through the protection path.

According to the present exemplary embodiment, there is provided an apparatus and method of performing a point-to-multipoint protection switching with respect to a connection having a failure when a failure occurs in a path for transmitting/receiving a packet and a connection node in an RMP connection network.

According to an aspect of the present invention, it is possible to perform rapid protection switching to an alternative path when a failure occurs on a transmitting/receiving path in a point-to-multipoint connection network, for example, an RMP connection network.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating an Ethernet linear protection switching structure defined in Telecommunication Standardization Sector of the International Telecommunications Union (ITU-T) G8031 according to a related art;

FIG. 2 is a diagram illustrating an example of a network configuration to which a per-leaf protection switching is applied in a rooted multipoint (RMP) connection network according to an embodiment of the present invention;

FIG. 3A is a diagram illustrating an example of an occurrence of a failure on a path to a leaf node from a root node in a network to which a protection switching is applied in an RMP connection path according to an embodiment of the present invention;

FIG. 3B is a block diagram illustrating a node, for example, a root node or a leaf node according to an embodiment of the present invention;

FIGS. 4A and 4B are timing diagrams illustrating a per-leaf protection switching process in a 1:1 revertive mode in the failure of FIG. 3A according to an embodiment of the present invention; and

FIGS. 5A and 5B are timing diagrams illustrating a per-leaf protection switching process in a non-revertive mode according to an embodiment of the present invention.

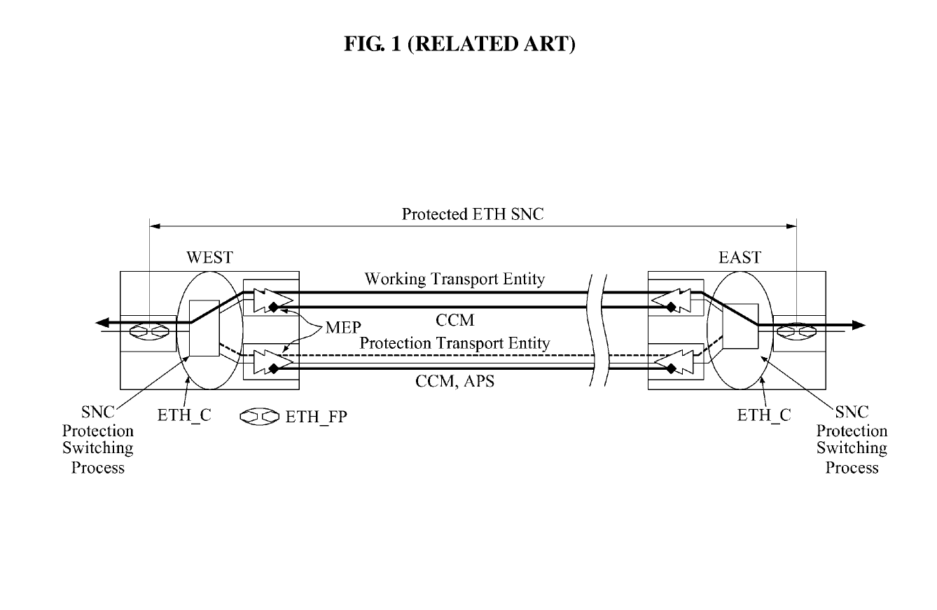

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

A term that includes an ordinal number, such as 1st, 2nd, can be used to describe the various components, but the components by the terms and is not limited. The ordinal description is used only to distinguish one component from another. For example, a first element, without departing from the scope of the present invention can be termed a second element, and, similarly, a second element could be termed a first element. As used herein, such terms are used for describing particular embodiments only, and are not intended to limit the present invention. As used herein, the term “and/or” includes any and all combinations of one or more of the associated listed items

It will be understood that when an element or layer is referred to as being “on” or “connected to” another element or layer, it can be directly on or operatively connected to the other element or layer or through intervening elements or layers may be present. In contrast, when an element is referred to as being “directly on” or “directly connected to” another element or layer, there are no intervening elements or layers present. Like reference numerals refer to like elements throughout. As used herein, the term “and/or” includes any and all combinations of one or more of the associated listed items.

As used herein, “contain” or “combination” terms not listed in the specification, features, integers, steps, operations, elements, components or combinations thereof that may specify one or more components should be understood as being precluded from the features, integers, steps, operations, elements, components, or combinations thereof, or the presence of additional possibilities.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning consistent with the meaning in the context of the relevant art and this disclosure,

In addition, as described with reference to the accompanying drawings, the same components and corresponding components are given the same reference number and corresponding drawings numbered duplicate description will be omitted. In describing the present invention, a detailed description of known techniques related to unnecessarily obscure the gist of the present invention, it is determined that the detailed description thereof will be omitted.

The present exemplary embodiments relate to a rooted multipoint (RMP) connection protection switching technology applicable to a point-to-multipoint network being used in various networks, such as an optical traffic network (OTN), Ethernet, carrier Ethernet, an Ethernet passive optical network (E-PON), a gigabit passive optical network (G-PON), provider backbone bridge traffic engineering (PBB-TE), a multiprotocol label switching (MPLS), MPLS-transport profile (TP), or a communication connection between a wireless terminal and an access point. The scope of the appended claims being unrestricted by a communications method is commonly understood by one of ordinary skill in the to which this invention belongs

The present exemplary embodiments are applied to a point-to-multipoint connection network, being a logical network, configured to connect a single root node to a plurality of leaf nodes, and transmit unicast traffic sent from a root node to a predetermined single leaf node, multicast traffic sent from a root node to a plurality of predetermined leaf nodes, broadcast traffic sent from a root node to all leaf nodes, and unicast traffic sent from a leaf node to a root node.

The network having such characteristics is referred to as an E-Tree defined by Metro Ethernet Forum (MEF) or an RMP connection network defined by the Institute of Electrical and Electronics Engineers (IEEE) and Telecommunication Standardization Sector of the International Telecommunications Union (ITU-T) in accordance with international standards. Also, a service including the aforementioned types of traffic is referred to as an E-Tree service, or an RMP connection service.

The terms “working path and protection path” as used herein include an OTN, an Ethernet network, a packet network, a transport path through which a packet is transmitted from a source to a destination in a packet transport network, a virtual tunnel, an exclusive network, a virtual channel, and a connection, and are hereinafter referred to as a “path” for conciseness and ease of description.

The term “message” as used herein includes an information transmission message used to perform a protection switching.

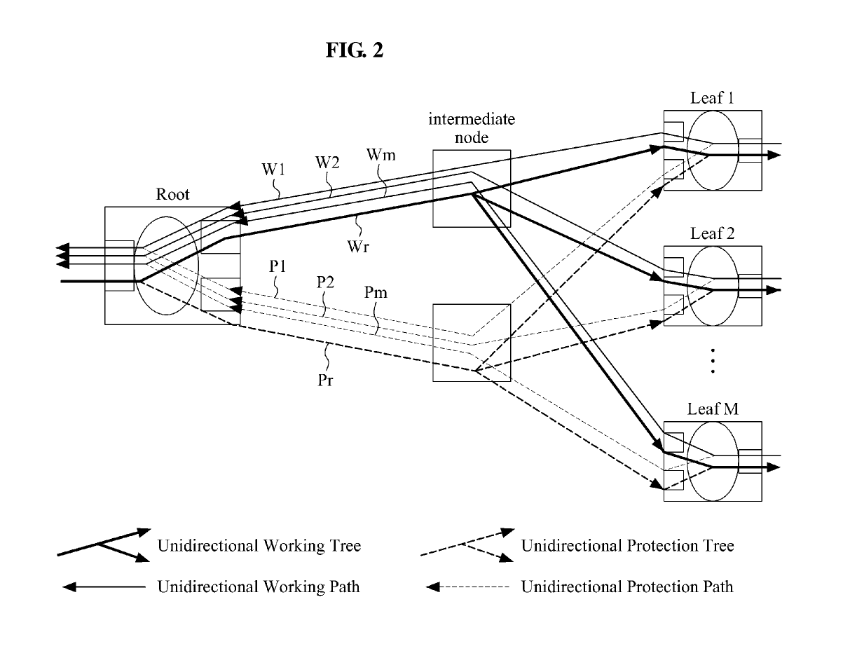

FIG. 2 is a diagram illustrating an example of a network configuration to which a per-leaf protection switching is applied in an RMP connection network according to an embodiment of the present invention. Referring to FIG. 2, a solid line and a dotted line indicate a unidirectional working tree and a unidirectional protection tree, respectively, in a direction leading from a root node to a plurality of leaf nodes, for example, Leaf 1 through Leaf M.

The root node is connected to the plurality of leaf nodes in a form of a tree to transmit/receive data with the plurality of leaf nodes. For example, the root node and the plurality of leaf nodes transmit/receive traffic based on one of a working tree and a protection tree.

When a working tree in a form of a single tree is in a point-to-multipoint connection, transmitting/receiving of traffic in unicast communication, multicast communication, and broadcast communication may be available from the root node to the plurality of leaf nodes. A plurality of nodes on a tree path performs a data copying for multicast communication and broadcast communication. A single asymmetric virtual local area network (VLAN) is assigned to such a unidirectional point-to-multipoint path connected in the form of the tree. Two trees, for example, a unidirectional working tree and a unidirectional protection tree, are needed for a protection switching to assign an asymmetric VLAN for each of the trees. The asymmetric VLANs assigned to the working tree and the protection tree are indicated as Wr and Pr, respectively, in FIG. 2.

The solid line and the dotted line of FIG. 2 indicate a unidirectional working path, for example, W1, W2, and Wm, and a unidirectional protection path, for example, a P1, P2, and Pm, leading from a single leaf node to a root node, respectively.

A single asymmetric VLAN is assigned for a point-to-point connection path leading from a single leaf node to a root node. Two paths are needed for each leaf node for a protection switching. For example, the two paths to which a single asymmetric VLAN is assigned may include a unidirectional working path and a unidirectional protection path. In an RMP connection network including a single root node and an M number of leaf nodes, a number of asymmetric VLANs required for the per-leaf protection switching is a total of “2+2M”. VLANs assigned to working paths and protection paths for the M number of leaf nodes are indicated by W1, W2, . . . , Wm, and P1, P2, . . . , Pm, respectively, in FIG. 2.

An RMP connection protection switching including such asymmetric VLANs may be based on a per-leaf protection switching method in which a protection switching is performed while managing a state between a working tree or a working path and a protection tree or a protection path in a point-to-point connection between a root node and a leaf node.

A conventional point-to-point linear protection switching method may include a 1+1 scheme and a 1:1 scheme. In the 1+1 scheme, both end nodes for a linear protection switching copy traffic, and transmit the copied traffic through a working path and a protection path at all times irrespective of an occurrence of a failure. In the 1:1 scheme, traffic is transmitted through the working path in an absence of a failure on the working path. For example, the 1:1 scheme uses a selector bridge that transmits traffic through the protection path in an occurrence of a failure on the working path, or a broadcast bridge that copies and transmits traffic through the working path and the protection path concurrently in an occurrence of a failure on the working path. In the conventional point-to-point linear protection switching method, both end nodes may operate in one identical scheme between the 1+1 scheme and the 1:1 scheme. In addition, both end nodes may select either of the selector bridge or the broadcast bridge, and may not combine two types of the bridges.

In the protection switching method in the point-to-multipoint connection network according to the present exemplary embodiments, a root node and a leaf node both transmit traffic through a working tree or a working path in an absence of a failure on the working tree or the working path. Conversely, in an occurrence of a failure on the working path, the root node copies traffic and transmits the copied traffic through the working tree and a protection tree concurrently while the leaf node transmits traffic through the working path and the protection path concurrently or through the protection path only. For example, according to the present exemplary embodiment, the root node may utilize the broadcast bridge while the leaf node may use the selector bridge or the broadcast bridge. Accordingly, the root node and the leaf node may combine two types of the bridges. When traffic is transmitted from a root node to all leaf nodes including a leaf node in a failure state in an occurrence of a failure, a change in a protection switching protocol message may be required. In response to the changed protection switching protocol message, the conventional point-to-point linear protection switching may need a corresponding change.

An independent and individual message exchange for each of a plurality of leaf nodes is performed between a root node and the plurality of leaf nodes for a per-leaf protection switching. For example, a message exchange with respect to a failure between the root node and a predetermined leaf node and an operation command is performed.

A protection switching structure in a point-to-multipoint network includes a per-leaf to protection switching and a per-tree protection switching. For example, the per-leaf protection switching transmits, through a protection tree, traffic corresponding to a leaf node that experiences suspended traffic transmission in an occurrence of a failure on a working tree of the point-to-multipoint network. The per-tree protection switching transmits traffic of all leaf nodes through the protection tree at once in an occurrence of a failure on the working tree of the point-to-multipoint network.

In general, the per-leaf protection switching forms a point-to-point connection between a root node and a plurality of leaf nodes, and includes a structure in which a number of point-to-point connections corresponds to a number of the plurality of leaf nodes. In an instance of an Ethernet network, a VLAN for a working path and a VLAN for a protection path are each assigned for a protection switching in a point-to-point connection between a leaf node and a root node. By way of example, a total of M number of VLANs is used to form the working tree and another M number of VLANs is used to form the protection tree in a point-to-multipoint network including an M number of leaf nodes, such that the per-leaf linear protection switching is performed for each of the M number of leaf nodes.

According to the present exemplary embodiments, a method of forming an asymmetric VLAN and a method of expanding the conventional point-to-point linear protection switching protocol, such as ITU-T G8031 are provided in order to describe a per-leaf protection switching method with respect to an RMP connection network.

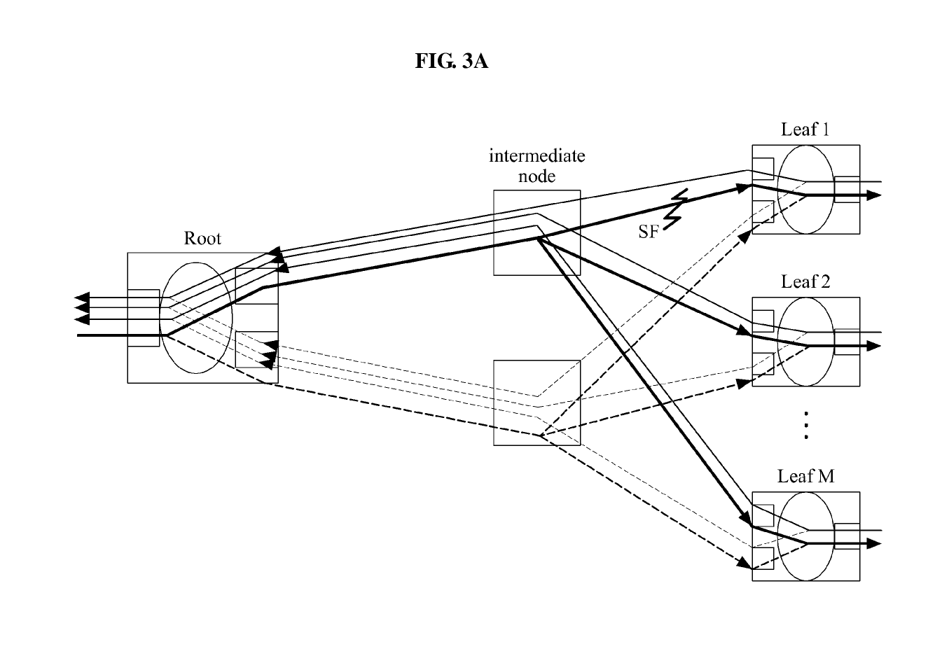

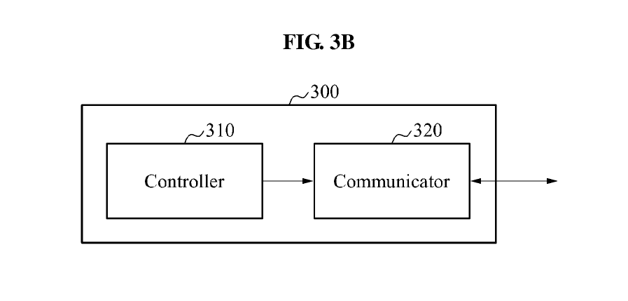

FIG. 3A is a diagram illustrating an example of an occurrence of a signal failure (SF) on a working path to a leaf node from a root node in a network to which a per-leaf protection switching is applied in an RMP connection path according to an embodiment of the present invention. Referring to FIG. 3A, an example of a leaf node, for example, Leaf 1, detecting the SF is provided.

FIG. 3B is a block diagram illustrating a node 300, for example, a root node or a leaf node according to an embodiment of the present invention.

Referring to FIG. 3B, the node 300 includes a controller 310 and a communicator 320.

The controller 310 controls the communicator 320 to perform communication with another node using a predetermined path between a working path and a protection path. The controller 310 may be implemented by an integrated circuit (IC) chip, a microprocessor, or a miniature computer. For example, the controller 310 may include the aforementioned bridge/selector or the selector/bridge, and operate based on an APS protocol. The controller 310 controls a protection switching process by analyzing a message received from the communicator 320, and generates a message required for the switching process. Also, the controller 310 controls the communicator 320 to transmit the generated message to another node.

The communicator 320 performs communication with another node. For example, the communicator 320 transmits a message received from the controller 310 to another node, or transmits a message received from another node to the controller 310. The communicator 320 may include various communication modules, for example, an antenna, a demodulator/modulator, a frequency processing apparatus, or a filter. The communicator 320 performs communication with another node via one of a working path or a protection path, and also performs communication while switching between the working path and the protection path during the protection switching process.

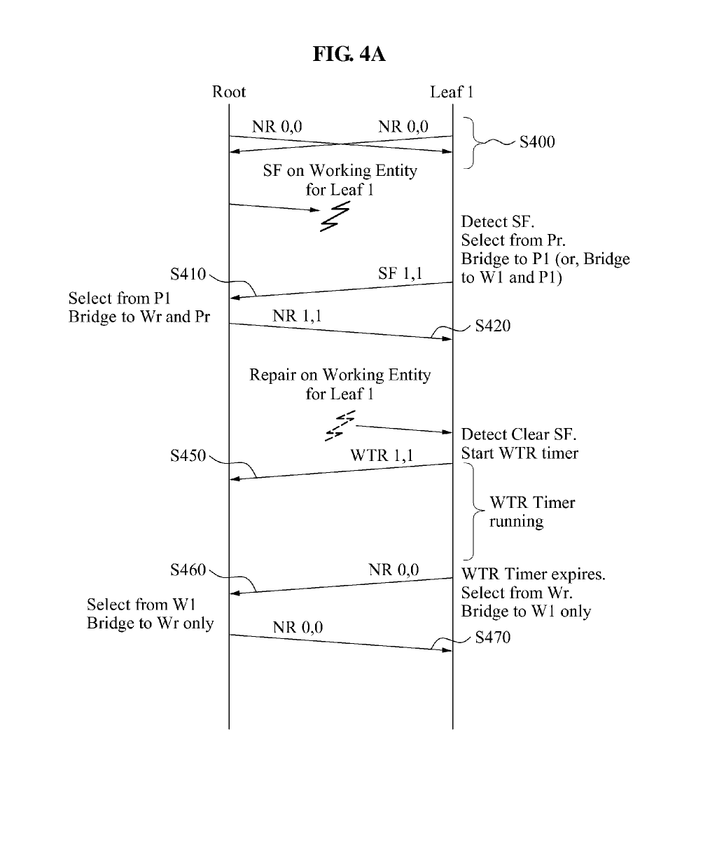

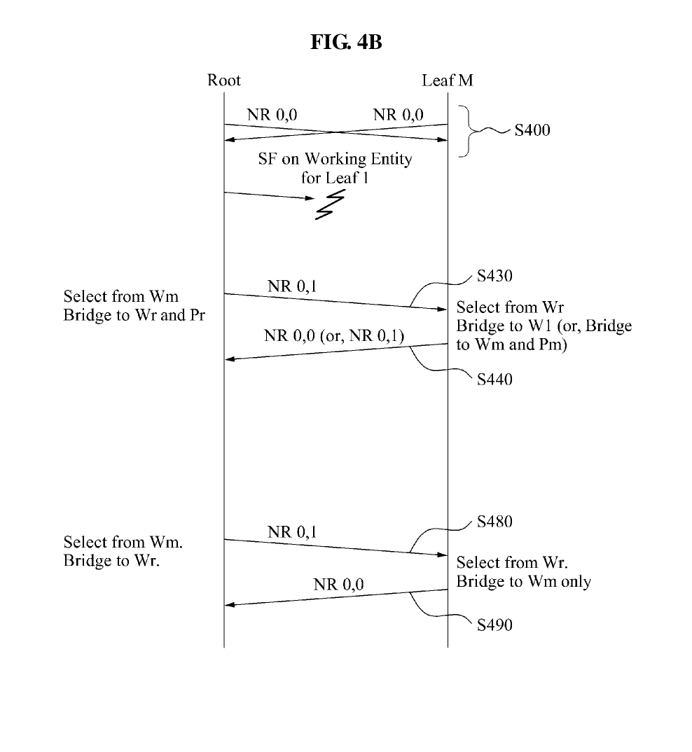

FIGS. 4A and 4B are timing diagrams illustrating an example of a per-leaf protection switching process in a 1:1 revertive mode in an occurrence of the failure of FIG. 3A.

As used herein, a term “1:1 scheme” refers to a method of transmitting traffic through one of a working tree path or a protection tree path. FIG. 4A illustrates a message exchange between a leaf node, for example, Leaf 1, detecting a failure and a root node, and a process of an operation thereof. FIG. 4B illustrates a message exchange between a plurality of leaf nodes, for example, Leaf 2, . . . , Leaf M, absent a failure and a root node, and a process of an operation thereof. Referring to FIG. 4B, Leaf M is selected as a representative example of a node absent a failure, and the same applies to a message exchange and an operation thereof between other remaining nodes absent a failure and the root node.

The message exchange in FIGS. 4A and 4B is indicated when a new message having a value differing from a previously occurring message occurs. When the new message differing from the previously occurring message occurs, a message transmission rule of the conventional linear protection switching may be observed, the rule including transmitting three messages as a preventative measure against a message loss, for example, within “3.3” milliseconds (msec) at intervals of five seconds. The time interval as used herein is merely exemplary, and that various modifications may be made to the present exemplary embodiment is easily understood by those skilled in the art.

In one example, a message exchanged between nodes in an ascending direction may include major state information and r/b information associated with bridge/selector information. “r/b” or “(r, b)” refers to information used to transmit information about a selection of a bridge and a selector associated with a working path and a protection path of a transmitting/receiving node, and to select traffic based on a protection state of a plurality of nodes.
“r” denotes a requested signal, and information indicating traffic to be transmitted through the protection path by a message transmitting node, for example, a first node, to a message receiving node, for example, a second node. When an r value is a null signal “0”, transmitting of traffic through the working path is requested rather than the protection path. When the r value is a normal traffic signal “1”, transmitting of traffic through the protection path is requested. When the second node transmits a message to the first node, the second node transmits traffic indicated in the r value.
“b” denotes a transmitted signal, and information indicating traffic to be transmitted through the protection path by the message transmitting node, for example, the first node. A b value being a null signal “0” indicates that traffic is not transmitted through the protection path. The b value being a normal traffic signal “1” indicates that traffic is transmitted through the protection path.

The major state information exchanged through a protection switching message may include a lockout of protection (LO) state in which transmitting/receiving of traffic is locked to be used in a working path, a signal failure on protection (SF-P) state in which a failure is detected on a protection path, a forced switching (FS) state in which traffic is forcefully transmitted/received via a protection path despite an occurrence of a failure, a signal failure on working (SF) state in which a failure is recognized on a working path, a signal degradation (SD) state in which an attenuation of a signal is recognized on a path, a manual switching (MS) state in which a request for a manual switching of a path is recognized, a wait to restore (WTR) state in which waiting is performed while operating a timer during a predetermined period of time until restoration prior to being reverted, an exercise (EXER) state for a trial, a reverse request (RR) state in which responding is performed by a trial, a do not revert (DNR) state in which traffic is transmitted/received via a protection path through a non-reversion, and a no request (NR) state absent a predetermined request or a command.

As used herein, the term “protection switching message” includes, for example, “NR (r, b)”, “NR r, b”, “SF (r, b)”, “SF r, b”, “WTR (r, b)”, or “WTR r, b”.

The per-leaf protection switching according to the present exemplary embodiment performs protection with respect to an entire tree path when a failure occurs within the tree path as described in the following with reference to FIGS. 4A and 4B.

In operation S400, a root node and a plurality of leaf nodes, for example, Leaf 1, . . . , Leaf M, are in a normal state and transmit/receive an NR (r/b=null) message, for example, “NR 0, 0”, prior to an occurrence of a failure. As used herein, the term “NR” refers to a current node in a no request state, for example, a state absent a valid command or a request directed to the current node. In this example, a bridge and a selector may select a working tree path.

In operation S410, Leaf 1 recognizing a failure on the working tree path transmits a signal failure (r/b=normal traffic signal) message, hereinafter also referred to as an SF message, to the root node. As used herein, the term “SF message” is interchangeably used with SF (1, 1), “SF 1, 1”, or a message requesting for a conversion into a protection path. “SF” refers to a state in which a current node recognizes a signal failure, for example, a working path failure. When the SF message is transmitted, a traffic selector selects a protection tree.

A traffic bridge transmits traffic through a protection path, or copies traffic and transmits the copied traffic through a working path and the protection path concurrently. In this example, the method of copying traffic and transmitting the copied traffic to both working and protection paths is used to avoid a network congestion caused when source address learning is not performed, an issue experienced in a method of transmitting an Ethernet packet when a bandwidth of a link connected to a leaf node is less than a bandwidth of a link connected to a root node in a point-to-multipoint network. Although the source address learning is not performed due to the bandwidth of the link connected to the leaf node being identical to the bandwidth of the link connected to the root node, traffic may be transmitted through the protection path in an absence of the network congestion.

Referring to FIG. 4B, Leaf M not recognizing a failure exhibits no change in a state.

Referring to FIG. 4A, when the root node receives the SF (r/b=normal traffic signal) message from Leaf 1 recognizing the occurrence of the failure, the root node copies all traffic transmitted to the plurality of leaf nodes, and transmits the copied traffic through the working tree and the protection tree concurrently. In this example, the broadcast bridge selects both of the working tree and the protection tree.

In operation S420, the root node transmits an NR (r/b=normal traffic signal) message, for example, NR (1, 1) or “NR 1, 1”, to Leaf 1. A selector receiving traffic selects the protection path. In operation S430, the root node transmits an NR (r=null signal, b=normal traffic signal) message, for example, NR (0, 1) or “NR 0, 1”, to Leaf M not recognizing the failure. The selector receiving traffic maintains the working path. For example, the root node switches a path towards a leaf node recognizing an occurrence of a failure from a working path to a protection path. Accordingly, the root node maintains transmitting/receiving of traffic with a leaf node not recognizing a failure through the working path.

When Leaf 1 recognizing the failure receives the NR (r/b=normal traffic signal) message from the root node, a protection switching process is verified to be completed. Leaf 1 may resume transmitting/receiving of an NR message with the root node.

When Leaf M not recognizing the failure receives the NR (0, 1) message from the root node, Leaf M recognizes that the root node transmits traffic through the working path and the protection path, and transmits traffic through the working path or both of the protection path and the working path. In this example, the method of copying traffic and transmitting the copied traffic to both of the working and protection paths is used to avoid a network congestion caused when source address learning is not performed, an issue experienced in the method of transmitting the Ethernet packet when a bandwidth of a link connected to a leaf node is less than a bandwidth of a link connected to a root node in a point-to-multipoint network. Although the source address learning is not performed due to the bandwidth of the link connected to the leaf node that is identical to the bandwidth of the link connected to the root node, traffic may be transmitted through the working path in an absence of the network congestion.

In operation S440, when a leaf node not recognizing a failure transmits traffic through a working path, an NR (0, 0) message is transmitted to a root node, and when traffic is copied to be transmitted to the working path and a protection path, an NR (0, 1) message is transmitted.

A selector receiving traffic from the leaf node not recognizing the failure in response to receiving the NR (0, 1) message maintains a working tree.

Leaf 1 operates as follows when the SF detected by Leaf 1 as previously described in FIGS. 4A and 4B is cleared.

In operation S450, Leaf 1 recognizing a clearance state of the SF, hereinafter also referred to as “Clear SF”, enters a WTR state for restoration, operates a WTR timer, and transmits a WTR (r/b=normal traffic signal) message, interchangeably used with WTR (1, 1), or “WTR 1, 1”.

As used herein, in a process in which a failure occurs on a working path and is cleared through restoration, the term “WTR state” refers to a state of waiting while operating a WTR timer until restoration is completed during a predetermined period of time in which a path is reverted from a protection path to the working path in a revertive mode.

In operation S460, when an additional failure or a request is absent and the WTR timer is suspended, Leaf 1 enters an NR state and transmits an NR (r/b=null signal) message, for example, NR (0, 0). In this example, a bridge and a selector may select the working path and the working tree.

In operation S470, the root node receiving the NR (0, 0) message receives traffic from the working path of Leaf 1, and transmits the NR (0, 0) message to Leaf node 1.

In operation S480, when a failure or an operator request is absent on working trees and working paths with respect to all of the leaf nodes in the network, the root node transmits traffic through the working tree and transmits the NR (0, 0) message to all of the leaf nodes.

In operation S490, a leaf node receiving the NR (0, 0) message receives traffic from the working tree, and transmits traffic through the working path.

At this point, a process of traffic being reverted to the working tree and the working path is completed.

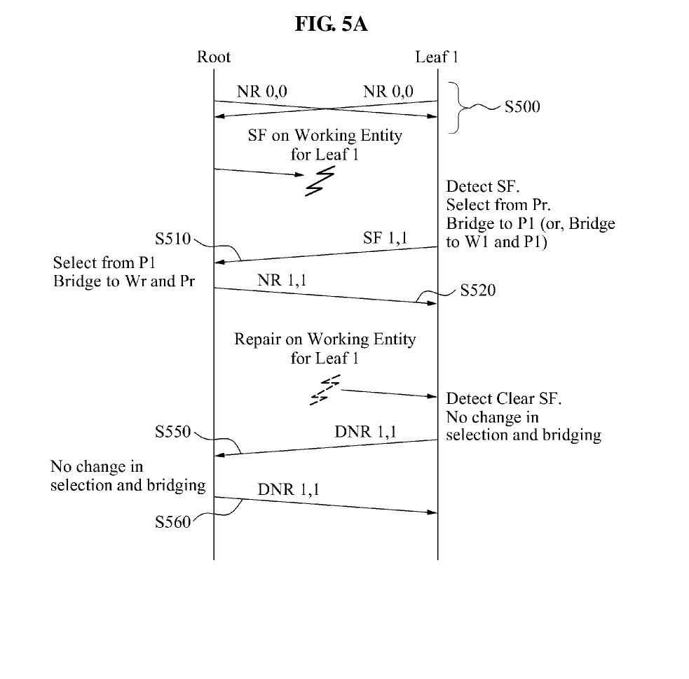

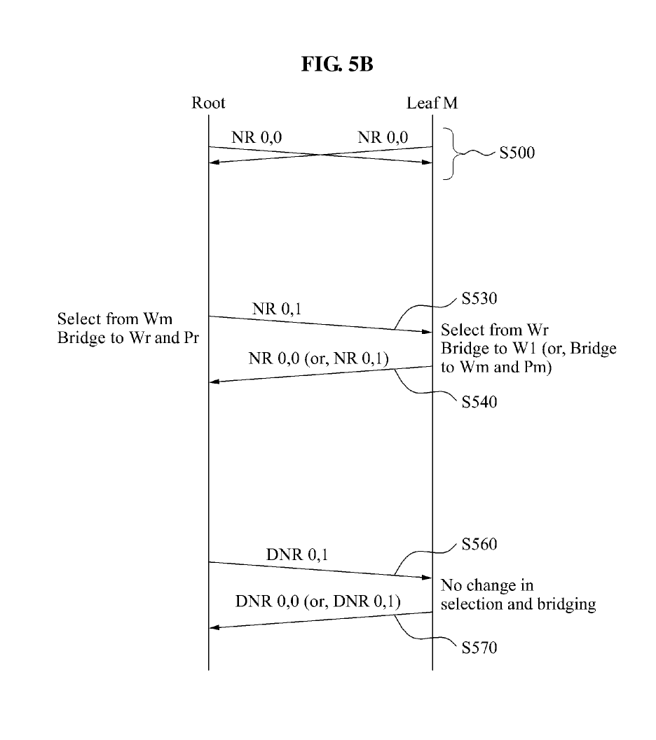

An example pertaining to a non-revertive mode will be described with reference to FIGS. 5A and 5B. The per-leaf protection switching according to the present exemplary embodiment is performed in a similar manner to FIGS. 4A and 4B when a failure occurs on a tree path.

In operation S500, a root node and a plurality of leaf nodes, for example, Leaf 1, . . . , Leaf M, are in a normal state, and transmit/receive an NR (r/b=null) message, for example, “NR 0, 0”, prior to an occurrence of a failure. As used herein, the term “NR” refers to a current node in a no request state, for example, a state absent a valid command or a request directed to the current node. In this instance, a bridge and a selector may select a working tree path.

In operation S510, Leaf 1 recognizing a failure on the working tree path transmits an SF (r/b=normal traffic signal) message to the root node. As used herein, the term “SF message” is interchangeably used with SF (1, 1), “SF 1, 1”, or a message requesting for a conversion into a protection path. “SF” refers to a state in which a current node recognizes a signal failure, for example, a working path failure. When the SF message is transmitted, a traffic selector selects a protection tree.

A traffic bridge transmits traffic through a protection path, or copies traffic and transmits the copied traffic through a working path and the protection path concurrently. In this example, the method of copying traffic and transmitting the copied traffic to both working and protection paths is used to avoid a network congestion caused when source address learning is not performed, an issue experienced in a method of transmitting an Ethernet packet when a bandwidth of a link connected to a leaf node is less than a bandwidth of a link connected to a root node in a point-to-multipoint network. Although the source address learning is not performed due to the bandwidth of the link connected to the leaf node being identical to the bandwidth of the link connected to the root node, traffic may be transmitted through the protection path in an absence of the network congestion.

Referring to FIG. 5B, Leaf M not recognizing a failure exhibits no change in a state.

Referring to FIG. 5A, when the root node receives the SF (r/b=normal traffic signal) message from Leaf 1 recognizing the occurrence of the failure, the root node copies all traffic transmitted to the plurality of leaf nodes, and transmits the copied traffic to the working tree and the protection tree concurrently. In this example, a broadcast bridge selects both of the working tree and the protection tree.

In operation S520, the root node transmits an NR (r/b=normal traffic signal) message, for example, NR (1, 1) or “NR 1, 1”, to Leaf 1. A selector receiving traffic selects a protection path. In operation S430, the root node transmits an NR (r=null signal, b=normal traffic signal) message, for example, NR (0, 1) or “NR 0, 1”, to Leaf M not recognizing the failure. The selector receiving traffic maintains the working path. For example, the root node switches a path towards a leaf node recognizing an occurrence of a failure from a working path to a protection path. Accordingly, the root node maintains transmitting/receiving of traffic with a leaf node not recognizing a failure through the working path.

When Leaf 1 recognizing the failure receives the NR (r/b=normal traffic signal) message from the root node, a protection switching process is verified to be completed. Leaf 1 may resume transmitting/receiving of an NR message with the root node.

When Leaf M not recognizing the failure receives the NR (0, 1) message from the root node, Leaf M recognizes that the root node transmits traffic through the working path and the protection path, and transmits traffic through the working path or both of the protection and working paths. In this example, the method of copying traffic and transmitting the copied traffic to both of the working and protection paths is used to avoid a network congestion caused when source address learning is not performed, an issue experienced in the method of transmitting the Ethernet packet when a bandwidth of a link connected to a leaf node is less than a bandwidth of a link connected to a root node in a point-to-multipoint network. Although the source address learning is not performed due to the bandwidth of the link connected to the leaf node that is identical to the bandwidth of the link connected to the root node, traffic may be transmitted through the working path in an absence of the network congestion.

In operation S540, when a leaf node not recognizing a failure transmits traffic to a working path, an NR (0, 0) message is transmitted to a root node, and when traffic is copied to be transmitted to the working path and a protection path, an NR (0, 1) message is transmitted.

A selector receiving traffic from the leaf node not recognizing the failure in response to receiving the NR (0, 1) message maintains a working tree.

When the SF detected by Leaf 1 as previously described in FIGS. 5A and 5B is cleared, Leaf 1 operates, as follows. In this example, the operation of Leaf 1 differs from a revertive mode in which a WTR timer is used.

In operation S550, Leaf 1 recognizing a clearance state of the SF, for example, “Clear SF”, enters a DNR state indicating reversion not being performed, and transmits a DNR (r/b=normal traffic signal) message, interchangeably used with DNR (1, 1) or “DNR 1, 1”.

As used herein, the term “DNR state” refers to a state in which a path is not reverted to a working path from a protection path subsequent to a failure occurring on the working path and being cleared through restoration in a non-revertive mode. The non-revertive mode is advantageous in that an operator may subsequently revert to a working path at an appropriate point in time, for example, a period of time having a small amount of traffic, in a dissimilar manner to an automatic reversion using a WTR timer.

In operation S560, the root node receiving the DNR (1, 1) message does not change a position of a selector with a position of a bridge while converting to the DNR state, transmits the DNR (1, 1) message to Leaf 1, and transmits a DNR (0, 1) message to Leaf M not recognizing a failure.

In operation S570, Leaf M receiving the NR (0, 1) message does not change the to position of the selector with the position of the bridge while converting to the DNR state, and transmits the DNR (0, 0) message or the DNR (0, 1) message.

Subsequently, traffic and the messages may maintain an identical state in an absence of an additional failure or an operator command.

When an operator wishes to withdraw from the non-revertive state and return to a normal state, an operator command, for example, a “manual switching to working” command and a “Clear” command, provided by the conventional linear protection switching, may be used.

The units described herein may be implemented using hardware components, software components, or a combination thereof. For example, a processing device may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer to storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of operating a root node, the method comprising:
receiving, from a first leaf node, a first signal failure (SF) message indicating an occurrence of a failure on a first working path corresponding to the first leaf node from among a plurality of leaf nodes that transmits/receives at least one of transmitting traffic and receiving traffic through a plurality of working paths;
receiving, from the first leaf node by switching the first working path to a first protection path, receiving traffic; and
receiving, from remaining leaf nodes aside from the first leaf node, receiving traffic through each of remaining working paths aside from the first working path.

2. The method of claim 1, further comprising:
transmitting a first no request (NR) message to each of the plurality of leaf nodes; and
receiving a second NR message from each of the plurality of leaf nodes.

3. The method of claim 1, further comprising:
copying transmitting traffic, and performing transmitting of the copied transmitting traffic through the first working path and the first protection path concurrently when the SF message is received.

4. The method of claim 1, further comprising:
transmitting, to the first leaf node, a third NR message indicating completion of the switching.

5. The method of claim 4, further comprising:
transmitting, to the remaining leaf nodes aside from the first leaf node, a fourth NR message that instructs a working path through which the transmitting/receiving of the transmitting traffic and the receiving traffic is performed be maintained.

6. The method of claim 1, further comprising:
receiving, from the first leaf node, a wait to restore (WTR) message indicating a clearance of the failure.

7. The method of claim 6, further comprising:
to determining that the failure in the first leaf node is cleared; and
receiving, from the first leaf node, a fifth NR message indicating that a WTR timer is suspended.

8. The method of claim 7, further comprising:
receiving, by switching to the first working path from the first protection path, receiving traffic when the 5 NR message is received.

9. A method of operating a leaf node, the method comprising:
transmitting/receiving, with a root node, at least one of transmitting traffic and receiving traffic through a working path;
detecting an occurrence of a failure on the working path;
receiving, by switching the working path to a protection path, receiving traffic;
transmitting a signal failure (SF) message indicating the occurrence of the failure on the working path; and
receiving a first no request (NR) message indicating that the root node performs the switching.

10. The method of claim 9, further comprising:
transmitting a second NR message to the root node; and
receiving a third NR message from the root node.

11. The method of claim 9, further comprising:
copying transmitting traffic and performing transmitting of the copied transmitting traffic through the working path and the protection path concurrently, or performing transmitting of transmitting traffic through the protection path.

12. The method of claim 9, further comprising:
transmitting a fourth NR message to the root node subsequent to the switching being performed.

13. The method of claim 9, further comprising:
detecting a clearance of the failure.

14. The method of claim 13, further comprising:
transmitting, to the root node, a wait to restore (WTR) message indicating the clearance of the failure.

15. The method of claim 14, further comprising:
transmitting the WTR message, and initiating a WTR timer; and
transmitting a fifth NR message to the root node in response to the WTR timer being suspended.

16. The method of claim 15, wherein the fifth NR message is a message that instructs the root node to receive receiving traffic by switching to the working path from the protection path.

17. The method of claim 15, further comprising:
transmitting/receiving at least one of transmitting traffic and receiving traffic by switching to the working path from the protection path in response to the WTR timer being suspended.

18. A root node, comprising:
a communicator to receive, from a first leaf node, a first signal failure (SF) message indicating an occurrence of a failure on a first working path corresponding to the first leaf node from among a plurality of leaf nodes that transmits/receives at least one of transmitting traffic and receiving traffic through a plurality of working paths; and
a controller to control the communicator to receive, from the first leaf node, receiving traffic by switching the first working path to a first protection path, and to receive, from leaf nodes remaining aside from the first leaf node, receiving traffic through each of working paths aside from the first working path.

19. A leaf node, comprising:
a communicator to transmit/receive, with a root node, at least one of transmitting traffic and receiving traffic through a working path; and
a controller to control the communicator to receive receiving traffic by switching the working path to a protection path when an occurrence of a failure is detected on the working path,
wherein the communicator transmits a signal failure (SF) message indicating the occurrence of the failure on the working path, and receives a first no request (NR) message indicating that the root node performs the switching.

20. The leaf node of claim 19, wherein the communicator copies transmitting traffic and performs transmitting of the copied transmitting traffic through a working path and a protection path concurrently, or transmits through the protection path.
